(19) United States
(12) Patent Application Publication
(10) Pub. No.: US 2012/0243115 A1
(43) Pub. Date: Sep. 27, 2012

(54) OPTICAL LAYERED BODY AND METHOD FOR PRODUCING OPTICAL LAYERED BODY

(75) Inventors: Hiroyuki Takamiya, Tokyo (JP); Kenji Ueno, Tokyo (JP); Masataka Ino, Tokyo (JP); Kenta Sato, Tokyo (JP)

(73) Assignee: Dai Nippon Printing Co., Ltd., Tokyo (JP)

(21) Appl. No.: 13/499,107

(22) PCT Filed: Sep. 30, 2010
(86) PCT No.: PCT/JP2010/067112

§ 371 Date: Jun. 12, 2012

(30) Foreign Application Priority Data
Sep. 30, 2009 (JP) 2009-229041

(51) Int. Cl. G02B 5/00; B05D 3/06

(52) U.S. Cl. 359/894; 427/558

(57) ABSTRACT

The present invention provides an optical layered body which prevents the occurrence of curling (warpage), has excellent durability while maintaining pencil hardness, and can prevent the degradation of durability of an image display screen by external light by using the optical layered body as a protective film of the image display screen.

An optical layered body including a light-transmitting substrate and at least a hard coat layer formed on the light-transmitting substrate, wherein the hard coat layer is formed by hardening a composition for a hard coat layer containing a polyfunctional (meth)acrylate ultraviolet curable resin, an ultraviolet absorber and a photopolymerization initiator by ultraviolet irradiation, and wherein the hard coat layer has a Martens hardness (A) of 230 to 320 N/mm² at the surface opposite to the light-transmitting substrate and has a Martens hardness (B) of 160 to 250 N/mm² at the surface on the side of the light-transmitting substrate, and the Martens hardness (A) is larger than the Martens hardness (B) and the elastic modulus of the hard coat layer varies continuously in the thickness direction.

### TECHNICAL FIELD

The present invention relates to an optical layered body and a method of producing an optical layered body.

### BACKGROUND ART

As protective films of image display screens such as a display, a monitor, a touch panel and the like, an optical layered body, which has functions such as a hard-coating property (abrasion resistance), an antistatic property (preventing dust from adhering thereto, prevention of alignment defect of liquid crystal due to charging), an antireflection property (improvement in visibility), an antiglare property and an antifouling property (preventing fingerprints from adhering thereto), is known.

In such an optical layered body, a triacetyl cellulose film (hereinafter, referred to as a TAC film) is used as a substrate particularly from the viewpoint that the TAC film is superior in birefringence and transparency if the film is used for a liquid crystal display. However, if the TAC film is used as a substrate, since it is difficult to form a film by a melt method, the substrate has to be produced by a casting method, and therefore the production cost is high. Thus, reduction in production cost is carried out by reducing the film thickness of the substrate from conventional 80 μm to 60 μm or 40 μm. Further, the TAC film includes an ultraviolet absorber and has a function of preventing the degradation of the image display screen by external light.

Further, in the above optical layered body, a hard coat layer having various functions is formed on the substrate in order to impart the above-mentioned functions. The hard coat layer is formed by applying a composition containing an additive for imparting a desired function and an ultraviolet curable resin onto the substrate to form a coating film, drying the coating film, and then irradiating the coating film with ultraviolet light to harden the coat. However, the ultraviolet curable resin tends to shrink by ultraviolet irradiation. Thus, curling of the optical layered body becomes remarkable as a thickness of the substrate is reduced, and therefore there is a problem that wrinkles in the TD direction (transverse direction) tends to be produced particularly in the case of roll processing and desired processing becomes difficult. Particularly, there is a problem that irregularity is remarkable in the optical layered body provided with an antiglare property.

In order to suppress such deformation of the optical layered body such as curling, a method of using a hard coat layer low in shrinkage and the like are conceivable. However, in such methods, when the hard coat layer is formed on a substrate having a small film thickness, this tends to impair the performance (particularly, hardness) of the hard coat layer.

In Patent Documents 1 and 2, a method in which a hard coating property is enhanced by disposing a high hardness layer on a layer having a high elastic modulus is disclosed. However, since this coating film has a multilayer structure, a production step becomes complicated, and on the contrary it leads to an increase in cost. Moreover, this method needs to achieve a total amount of irradiation required by decreasing the amount of irradiation per unit time and by increasing an irradiation time since heat generation through polymerization of a coating solution for a hard coat layer is large to cause thermal damage.

For example, in Patent Document 3, a hard coat film in which a first hard coat layer is disposed on a sheet substrate and a second hard coat layer having lower hardness than the first hard coat layer is disposed. However, since such a hard coat film has a multilayer structure and half-curing is required in order to form two types of hard coat layers having different hardnesses, this film has problems with an adhesive property to a sheet substrate and complication during the course of production.

For example, in Patent Document 4, a hard coat film is disclosed which has a transparent substrate and two layers or more of hard coat layers formed on the transparent substrate, in which the elastic modulus of a hard coat layer formed closest to the transparent substrate is higher than that of a hard coat layer of a surface layer. However, such a hard coat film requires coating many times in the step of forming thereof because of its multilayer structure, and has a problem of low processability.

On the other hand, as compositions for forming the above-mentioned hard coat layer, a composition has been conventionally known which includes an ultraviolet curable resin containing an ultraviolet absorber. When a coating film is formed on a substrate by the use of such a composition and the coating film is irradiated with ultraviolet light from the side opposite to the substrate, ultraviolet absorption by the ultraviolet absorber contained in the coating film occurs. Therefore, the amount of ultraviolet irradiation in the vicinity of the substrate side within the coating film is smaller than that in the vicinity of the surface side, and hardening inhibition occurs.

As a method of solving the hardening inhibition of the coating film including a composition containing an ultraviolet absorber to adequately harden the entire coating film, for example, there are known a method in which an ultraviolet absorber absorbing less ultraviolet light of 340 nm or more is selected (Patent Document 5), a method in which a compound absorbing a wavelength of a visible region of 380 to 440 nm is blended (Patent Document 6), a method of irradiating ultraviolet light from top surface and bottom surface (Patent Document 7), a method of hardening with electron beams (Patent Document 8), and the like.

Thus, conventionally, various investigations have been made for the purpose of uniformly and adequately hardening the entire coating film.

However, since common ultraviolet hardening is performed by irradiating ultraviolet light having high ultraviolet light intensity around a wavelength of 360 nm, in the inventions described in Patent Documents 5 to 8, while the entire coating film can be adequately hardened, the coating material close to the substrate also increases in hardness, and therefore problems such as wrinkles or irregularity cannot be adequately solved.

Moreover, in the invention described in Patent Document 7, facilities for hardening the coating film is expensive and the production cost increases, and there is also a problem that if a thin TAC film is used as a substrate, the strength of the TAC film is deteriorated.
Patent Document 1: Japanese Patent Publication No. 3073270
Patent Document 2: Japanese Patent Publication No. 4155651
Patent Document 3: Japanese Kokai Publication 2000-127281
Patent Document 4: Japanese Kokai Publication 2000-214791
Patent Document 5: Japanese Kokai Publication 2006-119476
Patent Document 6: Japanese Kokai Publication 2008-90067
Patent Document 7: Japanese Kokai Publication 2006-181430
Patent Document 8: International Publication WO 07/020,909 pamphlet

### DISCLOSURE OF THE INVENTION

### Problems to be Solved by the Invention

In view of the above state of the art, it is an object of the present invention to provide an optical layered body which prevents the occurrence of curling, has excellent durability while maintaining pencil hardness, and can prevent the degradation of durability of a image display screen by external light with the use of the optical layered body as a protective film of the image display screen.

### Means for Solving the Problems

The present invention pertains to an optical layered body including a light-transmitting substrate and at least a hard coat layer formed on the light-transmitting substrate, wherein the hard coat layer is formed by hardening a composition for a hard coat layer containing a polyfunctional (meth)acrylate ultraviolet curable resin, an ultraviolet absorber and a photopolymerization initiator by ultraviolet irradiation, and wherein the hard coat layer has a Martens hardness (A) of 230 to 320 N/mm² at the surface opposite to the light-transmitting substrate and has a Martens hardness (B) of 160 to 250 N/mm² at the surface on the side of the light-transmitting substrate, and the Martens hardness (A) is larger than the Martens hardness (B) and the elastic modulus of the hard coat layer varies continuously in the thickness direction.

The present invention also pertains to an optical layered body including a light-transmitting substrate and at least a hard coat layer formed on the light-transmitting substrate, wherein the hard coat layer is formed by hardening a composition for a hard coat layer containing a polyfunctional (meth)acrylate ultraviolet curable resin, an ultraviolet absorber and a photopolymerization initiator by ultraviolet irradiation, and wherein if the thickness of the hard coat layer from the surface opposite to the light-transmitting substrate to the surface on the side of the light-transmitting substrate is denoted by X₁ (μm) and a difference (A−B) between the Martens hardness (A) at the surface of the hard coat layer opposite to the light-transmitting substrate and the Martens hardness (B) at the surface of the hard coat layer on the side of the light-transmitting substrate is denoted by Y₁ (N/mm²), a relationship of the elastic modulus to the thickness of the hard coat layer is represented by Formula (1):

15 N/mm²/μm≦Y₁/X₁≦26 N/mm²/μm Formula (1).

In the optical layered body of the present invention, it is preferred that the hard coat layer has a rate (A) of polymerization of resin of 50 to 75% at the surface opposite to the light-transmitting substrate and has a rate (B) of polymerization of resin of 40 to 65% at the surface on the side of the light-transmitting substrate, and the rate (A) of polymerization of resin is larger than the rate (B) of polymerization of resin and the rate of polymerization of resin varies continuously in the thickness direction.

If the thickness of the hard coat layer from the surface opposite to the light-transmitting substrate to the surface on the side of the light-transmitting substrate is denoted by X₂ (μm) and the rate of polymerization of resin at the thickness X₂ (μm) is denoted by Y₂%, a variation in the rate of polymerization of resin within the hard coat layer is represented by Formula (2):

In Y₂=A×X₂+B,−1.3≦A≦−0.2 and 50≦B≦75 Formula (2).

In the above optical layered body, the ultraviolet absorber is preferably an addition-polymerization product of hydroxyphenyl benzotriazole (meth)acrylates, and/or a triazine compound in which four or more benzene rings are added and at least one of the benzene rings is substituted with a hydroxyl group.

At least one of the ultraviolet absorbers preferably has a weight average molecular weight of 500 to 50000, and the product of the film thickness (μm) of the hard coat layer and the concentration (mass %) of the ultraviolet absorber in the hard coat layer is preferably 4 to 150 (μm×mass %).

A calorific value is preferably 450 J/g or less in the case where the composition for a hard coat layer is formed into a coating film having a dried film thickness of 200 μm and the coating film is irradiated with ultraviolet light at an irradiation intensity of 10 mW/cm² and at an amount of irradiation of 150 mJ/cm².

The ultraviolet irradiation is preferably carried out under a lamp power of 100 to 1000 W/cm and an amount of irradiation of 15 to 1000 mJ/cm².

The hard coat layer preferably has a film thickness of 0.5 to 20 μm and the light-transmitting substrate preferably has a thickness of 20 to 80 μm.

The optical layered body preferably has a transmittance of 15% or less at a wavelength of 380 nm after the optical layered body is left standing for 100 hours in an environment of 80° C. and 90% RH.

In the case where the optical layered body is cut into a square sheet having a size of 10 cm long and 10 cm wide, and the sheet is suspended by holding two points on a side in the transverse direction of the sheet, which are respectively 4 mm away from the midpoint of the side in the transverse direction, a minimum distance between a line joining the respective midpoints of two sides in the transverse direction of the sheet and a line joining the respective midpoints of two sides in the length direction of the sheet is preferably 30 mm or less.

The present invention also pertains to a method of producing the above-mentioned optical layered body, including the steps of applying a composition for a hard coat layer containing a polyfunctional (meth)acrylate ultraviolet curable resin, an ultraviolet absorber and a photopolymerization initiator onto a light-transmitting substrate to form a coating film; and irradiating the formed coating film with ultraviolet light of a lamp power of 100 to 1000 W/cm and an amount of irradiation of 15 to 1000 mJ/cm² to harden the coating film, followed by formation of a hard coat layer, wherein a calorific value is 450 J/g or less in the case where the composition for a hard coat layer is formed into a coating film having a dried film thickness of 200 μm and the coating film is irradiated with ultraviolet light at an amount of irradiation of 150 mJ/cm².

Hereinafter, the present invention will be described in detail.

A first present invention pertains to an optical layered body including a light-transmitting substrate and at least a hard coat layer formed on the light-transmitting substrate, wherein the hard coat layer is formed by hardening a composition for a hard coat layer containing specific components by ultraviolet irradiation, and has a specific elastic characteristic in the thickness direction. Specifically, the composition for a hard coat layer contains a polyfunctional (meth)acrylate ultraviolet curable resin, an ultraviolet absorber and a photopolymerization initiator. The optical layered body of the present invention includes a hard coat layer in which polymerized states of an upper portion and an inner portion of the hard coat layer are controlled by positively using the hardening inhibition of the polyfunctional (meth)acrylate ultraviolet curable resin by the ultraviolet absorber. Accordingly, the optical layered body of the present invention hardly causes deformations such as curling, and has high pencil hardness and excellent durability. Further, if the optical layered body of the present invention is disposed in an image display device, the degradation of durability of the image display screen by external light can be favorably prevented.

In the optical layered body of the first present invention, the hard coat layer varies continuously in an elastic modulus in the thickness direction from the surface opposite to the light-transmitting substrate toward the surface on the side of the light-transmitting substrate, and the elastic modulus value of the surface opposite to the light-transmitting substrate is larger than the elastic modulus value of the surface on the side of the light-transmitting substrate.

That is, in the optical layered body of the present invention, the hard coat layer formed on the light-transmitting substrate varies continuously in an elastic modulus in the thickness direction within the hard coat layer and the elastic modulus in the vicinity of the surface (hereinafter, also referred to as a bottom side) on the side of the light-transmitting substrate is smaller than that in the vicinity of the surface (hereinafter, also referred to as an top side) opposite to the light-transmitting substrate. In the vicinity of the bottom surface where the elastic modulus is small, the distortion by shrinkage due to polymerization in forming the hard coat layer can be absorbed to prevent deformation such as curling and abrasion resistance can be improved by the action of absorbing a force applied to the surface of the optical layered body. On the other hand, in the vicinity of the top surface, high hardness (pencil hardness) can be maintained since the hard coat layer has a large elastic modulus. Since the optical layered body of the first present invention includes such a specific hard coat layer, it hardly causes deformation such as curling, and can have high pencil hardness. In the present invention, the Martens hardness is used as an index of the elastic modulus.

Since the optical layered body of the first present invention includes specific components including an ultraviolet absorber and has the hard coat layer exhibiting the above characteristics, it has high resistance to heat, humidity and light. Moreover, the optical layered body can prevent the degradation of durability of an image display screen by external light.

Moreover, since the optical layered body of the first present invention has the hard coat layer varying continuously in an elastic modulus between the top surface and the bottom surface of one layer, a production process becomes simple and therefore the production cost can be reduced.

In the optical layered body of the first present invention, there is a difference in an elastic modulus between the bottom surface and the top surface of the hard coat layer, and the elastic modulus of the top surface is larger than that of the bottom surface and the top surface is harder than the bottom surface.

The hard coat layer has a Martens hardness (A) of 230 to 320 N/mm² at the surface opposite to the light-transmitting substrate and has a Martens hardness (B) of 160 to 250 N/mm² at the surface on the side of the light-transmitting substrate.

If the Martens hardness (A) is less than 230 N/mm², the pencil hardness is insufficient, and if the Martens hardness (A) exceeds 320 N/mm², deformation such as curling or wrinkles tend to occur. It is more preferred since the hardness is good when the Martens hardness (A) is 280 to 320 N/mm².

If the Martens hardness (B) is less than 160 N/mm², the pencil hardness is low, and if the Martens hardness (B) exceeds 250 N/mm², it becomes difficult to prevent deformation such as curling or wrinkles. It is more preferable that the Martens hardness (B) is 185 to 230 N/mm² in terms of hardness. The value of the Martens hardness (A) is larger than that of the Martens hardness (B).

In addition, the Martens hardness (A) and the Martens hardness (B) are obtained by following a procedure in which an ultramicrohardness measurement system “FISCHERSCOPE PICODENTOR HM500 made in 2007” manufactured by Fischer Instruments K.K. is used, pushing strength into the hard coat layer is varied and an indenter is pushed in from a surface to a predetermined depth to measure a hardness in the vicinity of a surface (portion at a depth of about 0.5 μm from the surface) and a hardness in the vicinity of an interface (portion at a distance of 0.5 μm from the interface of the light-transmitting substrate, for example, if the film thickness of the hard coat layer is 4.5 μm, a portion at a depth of about 4 μm from the surface) between the hard coat layer and the light-transmitting substrate.

Further, an optical layered body including a hard coat layer in which the relationship of the elastic modulus to the thickness of a layer has a specific relationship also constitutes the present invention (hereinafter, also referred to as a second present invention).

That is, the optical layered body of the second present invention is an optical layered body including a light-transmitting substrate and at least a hard coat layer formed on the light-transmitting substrate, wherein the hard coat layer is formed by hardening a composition for a hard coat layer containing a polyfunctional (meth)acrylate ultraviolet curable resin, an ultraviolet absorber and a photopolymerization initiator by ultraviolet irradiation, and wherein if the thickness of the hard coat layer from the surface opposite to the light-transmitting substrate to the surface on the side of the light-transmitting substrate is denoted by X₁ (μm) and a difference (A−B) between the Martens hardness (A) at the surface of the hard coat layer opposite to the light-transmitting substrate and the Martens hardness (B) at the surface of the hard coat layer on the side of the light-transmitting substrate is denoted by Y₁ (N/mm²), a relationship of the elastic modulus to the thickness of the hard coat layer is represented by Formula (1):

15 N/mm²/μm≦Y₁/X₁≦26 N/mm²/μm Formula (1).

The optical layered body of the second present invention can be an optical layered body which hardly causes curling and has high pencil hardness by forming the hard coat layer having such an elastic modulus.

Further, in Formula (1), it is preferred to satisfy the following relationship:

0.5 μm≦X₁≦(film thickness−0.5)μm.

In addition, in the following invention, if the optical layered body of the first present invention is not distinguished from the optical layered body of the second present invention, these optical layered bodies will be described as the “optical layered body of the present invention”.

In the optical layered body of the present invention, the hard coat layer is formed by hardening a composition for a hard coat layer containing a polyfunctional (meth)acrylate ultraviolet curable resin, an ultraviolet absorber and a photopolymerization initiator by ultraviolet irradiation. Since a hard coat layer contains such specific components, it can be formed into an optical layered body which prevents the occurrence of curling, and has high pencil hardness and excellent durability. Further, if the optical layered body is disposed in an image display device, the degradation of durability of the image display screen by external light can be prevented.

The polyfunctional (meth)acrylate ultraviolet curable resin is not particularly limited as long as it has transparency, and examples thereof include pentaerythritol tri(meth)acrylate, pentaerythritol tetra(meth)acrylate, dipentaerythritol tri(meth)acrylate, dipentaerythritol tetra(meth)acrylate, pentaerythritol penta(meth)acrylate, dipentaerythritol hexa(meth)acrylate, trimethylolpropane tri(meth)acrylate and a pentaerythritol triacrylate hexamethylene diisocyanate urethane polymer; and polyfunctional (meth)acrylates such as (meth)acrylacrylates obtained by modifying urethane acrylate, ester acrylate, epoxy acrylate or ether acrylate, and EO modified product thereof.

Among these, (meth)acrylates, in which the number of functional groups per a molecular weight is large, such as pentaerythritol triacrylate (PETA) and dipentaerythritol hexaacrylate (DPHA) are preferable in that these can enhance the hardness (pencil hardness) of the optical layered body.

These resins may be used singly or in combination of two or more thereof.

In addition, in the present specification, “(meth)acrylate” includes “acrylate” and “methacrylate”. Also, in the present specification, “resin” refers to all of compounds having reactivity such as monomers, oligomers and prepolymers.

As the polyfunctional (meth)acrylate ultraviolet curable resin, a commercialized product may be used, and for example, UV-1700B, UV-6300 B (produced by Nippon Synthetic Chemical Industry Co., Ltd.), or Beamset 371 (produced by Arakawa Chemical Industries, Ltd.) may be used.

Examples of the ultraviolet absorber include benzophenone compounds such as 2,4-dihydroxybenzophenone, 2-hydroxy-4-methoxybenzophenone, 2-hydroxy-4-octoxybenzophenone, 2-hydroxy-4-dodecyloxybenzophenone, 2,2′-dihydroxy-4-methoxybenzophenone, 2,2′-dihydroxy-4,4′-methoxybenzophenone, 2-hydroxy-4-methoxy-5-sulfobenzophenone and bis(2-methoxy-4-hydroxy-5-benzoylphenyl)methane; benzotriazole compounds such as 2-(2′-hydroxy-5′-methylphenyl)benzotriazole, 2-(2′-hydroxy-5′-tert-butylphenyl)benzotriazole, 2-(2′-hydroxy-3′,5′-tert-butylphenyl)benzotriazole, 2-(2′-hydroxy-3′,5′-tert-butyl-5′-methylphenyl)-5-chlorobenzotriazole, 2-(2′-hydroxy-3,5′-ditert-butyl-5′-methylphenyl)-5-chlorobenzotriazole, 2-(2′-hydroxy-3,5′-ditert-amylphenyl)benzotriazole, 2-{2′-hydroxy-3′-(3′,4′,5′,6′-tetrahydrophthalimidemethyl)-5′-methylphenyl}benzotriazole, 2,2′-methylenebis{4-(1,1,3,3-tetramethylbutyl)-6-(2H-benzotriazole-2-yl)phenol} and 2-(2′-hydroxy-5′-methacryloxyphenyl)-2H-benzotriazole; cyanoacrylate compounds such as 2-ethylhexyl-2-cyano-3,3′-diphenyl acrylate and ethyl-2-cyano-3,3′-diphenyl acrylate; and the like.

The ultraviolet absorber is preferably addition-polymerization products of hydroxyphenyl benzotriazole (meth)acrylates, and/or triazine compounds in which four or more benzene rings are added and at least one of the benzene rings is substituted with a hydroxyl group. These may be used singly or in combination of two or more thereof.

At least one of the above-mentioned ultraviolet absorbers preferably has a weight average molecular weight of 500 to 50000.

If the weight average molecular weight of the ultraviolet absorber is less than 500, the ultraviolet absorber may be eluted or may be volatilized. If the weight average molecular weigh exceeds 50000, the compatibility with an ultraviolet curable resin may be deteriorated, or viscosity increases and processability may be deteriorated. The weight average molecular weigh is more preferably 550 to 30000, and moreover preferably 600 to 30000. That is, by selecting the molecular weigh in this range, a function of preventing the degradation of durability of an image display screen by external light is enhanced and a lifetime of the mage display screen can be lengthened.

In addition, the weight average molecular weight is a value obtained by gel permeation chromatography (in terms of polystyrene).

Specific examples of the addition-polymerization products of hydroxyphenyl benzotriazole (meth)acrylates having a weight average molecular weight (hereinafter, sometimes referred to as a molecular weight) of 500 to 50000 include PUVA-30M and PUVA-30S produced by Otsuka Chemical Co., Ltd., addition-polymerization products of these alone and compounds obtained by copolymerizing these with a copolymerizable monofunctional monomer such as methyl methacrylate, styrene or vinyl acetate so as to have a molecular weight of 500 to 50000. In the case of the above-mentioned copolymerization, the content of the copolymerizable monofunctional monomer is preferably 75% by mass or less of the whole ultraviolet absorber. If the content of the copolymerizable monofunctional monomer exceeds 75% by mass, it may become difficult to maintain the top surface of the hard coat layer at high hardness since it is necessary to add a large amount of the ultraviolet absorber to the composition for a hard coat layer.

Also, specific examples of the addition-polymerization products include addition-polymerization products obtained by replacing CH₂═C(CH₃)COOHCH₂CH₂ of RUVA-93 (produced by Otsuka Chemical Co., Ltd.) with CH₂═C(CH₃)COOHCH₂CH(OH)CH₂O, and addition-polymerizing the replaced RUVA-93 with the copolymerizable monofunctional monomer so as to have a predetermined molecular weight.

Specific examples of the triazine compounds having a weight average molecular weight of 500 to 50000, in which four or more benzene rings are added and at least one of the benzene rings is substituted with a hydroxyl group, include TINUVIN 405 and TINUVIN 479 produced by Ciba Specialty Chemicals Inc.; compounds having a structure in which a benzene ring is added to TINUVIN 400, TINUVIN 405 or TINUVIN 411L; compounds obtained by converting a portion of C₈H₁₇OCO of TINUVIN 479 to (meth)acrylate, and addition-polymerizing the converted TINUVIN 479 so as to have a molecular weight of 50000 or less; and compounds obtained by converting a portion of C₁₂H₂₅O or C₁₃H₂₇O of the TINUVIN 400 provided with a benzene ring to (meth)acrylate, and addition-polymerizing the converted TINUVIN 400 so as to have a molecular weight of 50000 or less; and the like.

If the addition-polymerization is performed, copolymerization may be performed, and examples of the copolymerizable monofunctional monomer for copolymerization include methyl methacrylate, styrene, and vinyl acetate, and methyl methacrylate and styrene are preferable. Further, in the case of the above-mentioned copolymerization, the content of the copolymerizable monofunctional monomer is preferably 75% by mass or less of the whole ultraviolet absorber. If the content of the copolymerizable monofunctional monomer exceeds 75% by mass, it may become difficult to maintain the top surface of the hard coat layer at high hardness since it is necessary to add a large amount of the ultraviolet absorber to the composition for a hard coat layer.

If the ultraviolet absorber contains the above addition-polymerization products of hydroxyphenyl benzotriazole (meth)acrylates and/or the triazine compounds in which four or more benzene rings are added and at least one of the benzene rings is substituted with a hydroxyl group, together with a compound other than these compounds, the content of the addition-polymerization products of hydroxyphenyl benzotriazole (meth)acrylates and/or the triazine compounds in which four or more benzene rings are added and at least one of the benzene rings is substituted with a hydroxyl group is preferably 35% by mass or more, and more preferably 50% by mass or more of the whole ultraviolet absorber. If the content is less than 35% by mass, it may become difficult to maintain the top surface of the hard coat layer at high hardness since it is necessary to add a large amount of the ultraviolet absorber to the composition for a hard coat layer.

In addition, the addition-polymerization products of hydroxyphenyl benzotriazole (meth)acrylates preferably contains hydroxyphenyl benzotriazole (meth)acrylate in an amount of 35% by mass or more. The amount of 35% by mass or more refers to a blending ratio of a monomer. If the amount is less than 35% by mass, it may become difficult to maintain the top surface of the hard coat layer at high hardness since it is necessary to add a large amount of the ultraviolet absorber to the composition for a hard coat layer.

The amount of the contained ultraviolet absorber is preferably 4 to 150 μm×mass % in terms of the product of the film thickness (μm) of the hard coat layer and the concentration (mass %) of the ultraviolet absorber in the hard coat layer. If the amount of the contained ultraviolet absorber is less than 4 μm×mass %, the sufficient effect of removing ultraviolet light cannot be achieved, and therefore the durability of a substrate, a liquid crystal or the like located at the position of a lower layer may be deteriorated. If the amount of the contained ultraviolet absorber exceeds 150 μm×mass %, adequate hardening of the ultraviolet curable resin may be suppressed to fail in attaining desired hardness.

The amount of the contained ultraviolet absorber is more preferably 10 to 100 μm×mass %.

The hard coat layer contains a photopolymerization initiator.

Examples of the photopolymerization initiator include acetophenones (for example, trade name “Irgacure 184”, 1-hydroxy-cyclohexyl-phenyl-ketone produced by Ciba Specialty Chemicals Inc., and trade name “Irgacure 907”, 2-methyl-1[4-(methylthio)phenyl]-2-morpholinopropan-1-one produced by Ciba Specialty Chemicals Inc., benzophenones, thioxanthones, benzoin, benzoin methyl ether, an aromatic diazonium salt, an aromatic sulfonium salt, an aromatic iodonium salt, a metallocene compound and benzoin sulfonate. These compounds may be used singly or in combination of two or more thereof. Further, it is preferred to use these in combination with trader name Irgacure 127 (2-hydroxy-1-{4-[4-(2-hydroxy-2-methyl-propionyl)-benzyl]-phenyl}-2-methyl-propan-1-one produced by Ciba Specialty Chemicals Inc.) in that surface hardening is high. By using a photopolymerization initiator having high surface hardening, it is possible to increase abrasion resistance and surface hardness. In addition to this, it is also possible to use these in combination with 2-benzyl-2-dimethylamino-1-(4-morpholinophenyl)-1-butanone or 2-dimethylamino-2-(4-methyl-benzyl)-1-(4-morpholin-4-yl-phenyl)-butan-1-one.

The content of the photopolymerization initiator is preferably 1 to 15% by mass of the hard coat layer. If the content is less than 1% by mass, a polymerization reaction may become insufficient and hardness is insufficient. If the content exceeds 15% by mass, the photopolymerization initiator may be precipitated, or the hard coat layer may be brittle. The content of the photopolymerization initiator is more preferably 3 to 8% by mass.

The hard coat layer may contain a photostabilizer.

Examples of the photostabilizer include hindered amine photostabilizers. Examples of commercialized products of the photostabilizer include TINUVINs 123, 144, 152 and 292 produced by Ciba Specialty Chemicals Inc., and FA 712HM and FA 711HM produced by Hitachi Chemical Co., Ltd.

The content of the photostabilizer is preferably 0.05 to 8% by mass of the hard coat layer.

The hard coat layer may contain an antiglare agent.

It is possible to impart an antiglare property to the hard coat layer by containing the antiglare agent.

Examples of the antiglare agent include metal oxides and organic resin beads.

As the metal oxide, silica is preferred. The type of silica is not particularly limited and any type of crystalline, sol-like and gel-like silicas may be used, or either amorphous silica or spherical silica may be used.

The organic resin bead is preferably at least one selected from the group consisting of acrylic beads (refractive index: 1.49 to 1.53), polyethylene beads (refractive index: 1.50), polystyrene beads (refractive index: 1.58 to 1.60), styrene-acrylic copolymer beads (refractive index: 1.54 to 1.57), polycarbonate beads (refractive index: 1.57), polyvinyl chloride beads (refractive index: 1.60), melamine beads (refractive index: 1.57), benzoguanamine-formaldehyde condensate beads (refractive index: 1.66), melamine-formaldehyde condensate beads (refractive index: 1.66), benzoguanamine-melamine-formaldehyde condensate beads (refractive index: 1.66) and benzoguanamine-melamine condensate beads (refractive index: 1.66). These may be used singly or in combination of two or more thereof.

Also, the metal oxide and the organic resin bead may be used in combination.

The average primary particle diameter of the antiglare agent is not particularly limited, but an average particle diameter as monodispersed particles and/or aggregated particles within the hard coat layer is preferably 0.5 to 10.0 μm. If the average particle diameter is less than 0.5 μm, an antiglare effect may be decreased. If the average particle diameter exceeds 10.0 μm, the additive amount of the antiglare agent increases, and optical properties may be adversely affected when an optical layered body is formed. The average particle diameter is more preferably 2.0 to 6.0 μm.

The content of the antiglare agent is preferably 1.0 to 12.0% by mass, and more preferably 2.5 to 8.5% by mass.

The hard coat layer may include other additives as required to an extent not impairing the effect of the present invention in addition to the components described above.

Examples of the additives include a polymer, a thermally polymerizable monomer, a thermal polymerization initiator, a leveling agent, a crosslinking agent, a curing agent, a polymerization accelerator, a viscosity adjustment agent, an antistatic agent, an antioxidant, an antifouling agent, a slip agent, a refractive index adjustment agent and a dispersant. Publicly known additives can be used therefor.

The hard coat layer is formed by the use of the composition for a hard coat layer prepared by mixing and dispersing the above polyfunctional (meth)acrylate ultraviolet curable resin, the ultraviolet absorber, the photopolymerization initiator, and the above-mentioned additives as required together with a solvent.

The above solvent may be appropriately selected according to the kind and solubility of a binder resin, and examples thereof include alcohols such as methanol, ethanol, isopropyl alcohol, butanol, isobutyl alcohol, methyl glycol, methyl glycol acetate, methyl cellosolve, ethyl cellosolve, and butyl cellosolve; ketones such as acetone, methyl ethyl ketone, methyl isobutyl ketone, cyclohexanone, and diacetone alcohol; esters such as methyl formate, methyl acetate, ethyl acetate, ethyl lactate, and butyl acetate; nitrogen-containing compounds such as nitromethane, N-methylpyrrolidone, and N,N-dimethylformamide; ethers such as diisopropyl ether, tetrahydrofuran, dioxane, and dioxolane; halogenated hydrocarbons such as methylene chloride, chloroform, trichloroethane, and tetrachloroethane; toluene, dimethyl sulfoxide and propylene carbonate; and mixtures of two or more thereof. Among these, examples of preferable solvents include at least one of toluene, cyclohexanone, methyl acetate, ethyl acetate, butyl acetate, methyl ethyl ketone and methyl isobutyl ketone.

The above-mentioned composition for a hard coat layer can be prepared by mixing each component uniformly, and each component may be mixed by the use of a publicly known apparatus such as a paint shaker, a beads mill or a kneader.

If the composition for a hard coat layer is formed into a coating film having a dried film thickness of 200 μm, and the product of the film thickness (μm) of the hard coat layer and the concentration (mass %) of the ultraviolet absorber in the hard coat layer satisfies 4 to 150 μm×mass %, a calorific value is preferably 450 J/g or less in the case of irradiating the coating film with ultraviolet light at an irradiation intensity of 10 mW/cm² and at an amount of irradiation of 150 mJ/cm².

If the calorific value exceeds 450 J/g, the light-transmitting substrate may be damaged by heat. The calorific value is more preferably 350 J/g or less.

By applying the above-mentioned ultraviolet absorber, the calorific value can be kept within the above range.

The hard coat layer is formed, for example, by applying a composition for a hard coat layer on a light-transmitting substrate, described later, to form a coating film, drying the coating film as required, and then hardening the coating film by irradiation of ultraviolet light to the coat.

Examples of a method of forming the coating film include various publicly known methods such as a spin coating method, a dip coating method, a spray coating method, a die coating method, a gravure coating method, a bar coating method, a roller coating method, a comma coating method, a slit reverse method, a meniscus coating method, a flexography method, a screen printing method, and a bead coating method. Among these, a die coating method, a slit reverse method and a comma coating method, which can be formed in the form of a roll, are preferred.

A method of drying the coating film is not particularly limited and publicly known methods can be applied, but it is preferred to dry at 60 to 110° C. for 30 seconds to 2 minutes from the viewpoints of heat resistance of the transparent substrate, a drying property of the solvent and productivity.

A method of irradiating the coating film with ultraviolet light is not particularly limited and a publicly known method of using a common ultraviolet source may be employed.

Specific examples of the ultraviolet source include light sources such as an ultra high-pressure mercury lamp, a high-pressure mercury lamp, a low-pressure mercury lamp, a carbon arc lamp, a black light fluorescent lamp and a metal halide lamp. As the wavelength of the ultraviolet light, a wavelength band of 190 to 380 nm can be used, and intense light of ultraviolet light having particularly a wavelength around 360 nm is commonly used. Specific examples of an electron beam source include various electron beam accelerators of a Cockcroft-Walton type, a van de Graaff type, a resonance transformer type, an insulating core transformer type, or a linear type, a Dynamitron type and a high-frequency type.

The ultraviolet irradiation is preferably carried out while removing oxygen.

The ultraviolet irradiation is preferably carried out under a lamp power of 100 to 1000 W/cm.

If the lamp power is less than 100 W/cm, in the vicinity of the light-transmitting substrate, since the intensity of ultraviolet light is decreased in the vicinity of the light-transmitting substrate by the ultraviolet absorber contained in the hard coat layer, insufficient hardening occurs and sufficient reaction points may not be produced at the surface, and therefore a sufficient surface-crosslinking density may not be attained. In addition to this, the production rate becomes extremely low. If the lamp power exceeds 1000 W/cm, though a sufficient crosslinking density can be attained, heat damage occurs due to rapid heat generation and therefore the hard coat layer may not be attained.

The lamp power is more preferably 150 to 350 W/cm.

The ultraviolet irradiation is preferably carried out under an amount of irradiation of 15 to 1000 mJ/cm².

If the amount of irradiation is less than 15 mJ/cm², hardening may be insufficient. If the amount of irradiation exceeds 1000 mJ/cm², curling or damage may be produced in the optical layered body due to heat generation. The amount of irradiation is more preferably 30 to 300 mJ/cm².

As a method of ultraviolet irradiation, it is preferred that the coating film is not irradiated gradually over time, but the coating film is irradiated at once. According to this method, in general, curling and damage of the optical layered body becomes worse, but by using an ultraviolet absorber and a photopolymerization initiator which has highly surface hardening, since the elastic modulus of the hard coat layer is high at the outermost surface but is moderately continuously decreased toward an inside, the hardness of the surface can be secured and curling and damage can be prevented.

By forming a hard coat layer under the specific conditions with the use of the composition for a hard coat layer containing a specific ultraviolet absorber, ultraviolet curable resin and photopolymerization initiator as described above, it is possible to favorably form the hard coat layer varying continuously in an elastic modulus in the thickness direction from the surface opposite to the light-transmitting substrate toward the surface on the side of the light-transmitting substrate.

It is conceivable that such a hard coat layer can be attained for the following reasons. That is, when ultraviolet light is irradiated to a coating film formed by applying a composition for a hard coat layer containing an ultraviolet absorber from the top surface of the hard coat layer (surface opposite to the light-transmitting substrate) under the above-mentioned conditions, the absorption of the ultraviolet light by the ultraviolet absorber occurs. Then, within the coating film, the amount of ultraviolet irradiation in the vicinity of the bottom surface (surface on the side of the light-transmitting substrate) is smaller than the amount of ultraviolet irradiation in the vicinity of the top surface. Thus, it is possible to control in such a way that the intensity of the ultraviolet light reaching the inside of the coating film decreases gradually in the thickness direction from the top surface to the bottom surface of the coating film. As a result, since in the vicinity of the top surface, the intensity of the ultraviolet light is high and the number of initiating points of polymerization of the polyfunctional (meth)acrylate ultraviolet curable resin is large, polymerization occurs rapidly, and a crosslinking density increases though a polymer chain is short, and a high hardness layer having a desired elastic modulus is formed. On the other hand, within the coating film, since the intensity of the ultraviolet light is reduced as the ultraviolet light approaches the bottom surface, the number of initiating points of polymerization of the polyfunctional (meth)acrylate ultraviolet curable resin is decreased, and polymerization proceeds gradually to reduce a degree of crosslinking, and thereby a polymer chain is lengthened though a crosslinking density is low. At the bottom surface, a layer having a desired elastic modulus, in which hardness is low but toughness is high, is formed. It is conceivable that as described above, a hard coat layer having a specific elastic characteristic described above can be formed.

By forming the hard coat layer under the above conditions with the use of the composition for a hard coat layer as described above, it is possible to uniformly provide the crosslinking density with irregularity within the hard coat layer of a single layer, and to form a layer in which the elastic modulus varies continuously in the range of selected values such that the elastic modulus is large at the top surface and small at the bottom surface. For this reason, even though a light-transmitting substrate having a small film thickness is used, an optical layered body, in which the occurrence of deformation such as curling or wrinkles can be prevented by virtue of the lower layer having a small elastic modulus, can be formed. Further, the top surface of the hard coat layer can have high hardness. Moreover, since the hard coat layer contains the ultraviolet absorber, the degradation of durability of an image display screen by external light can be prevented, and therefore an overall calorific value through a polymerization reaction can be prevented and a thermal damage can be reduced even though ultraviolet light with high intensity is irradiated in forming the hard coat layer.

Further, in the hard coat layer, a degree of polymerization varies continuously in the thickness direction. That is, the hard coat layer in the optical layered body of the present invention varies continuously in the degree of polymerization in the thickness direction within one layer.

The optical layered body of the present invention including such a hard coat layer hardly causes deformation of a sheet such as curling, and has high pencil hardness and high resistance to heat, humidity and light. Further, when the optical layered body of the present invention is disposed in an image display device, the degradation of durability of the image display screen by external light can be favorably prevented.

The hard coat layer preferably has a rate (A) of polymerization of resin of 50 to 75% at the surface opposite to the light-transmitting substrate and has a rate (B) of polymerization of resin of 40 to 65% at the surface on the side of the light-transmitting substrate.

If the rate (A) of polymerization of resin is less than 50%, the pencil hardness may become insufficient, and if the rate (A) of polymerization of resin exceeds 75%, curling or damage may occur. The rate (A) of polymerization of resin is more preferably 55 to 65%.

If the rate (B) of polymerization of resin is less than 40%, the pencil hardness may decrease, and if the rate (B) of polymerization of resin exceeds 65%, curling, wrinkle or the like may be produced. The rate (B) of polymerization of resin is more preferably 45 to 60%.

The rate (A) of polymerization of resin is larger than the rate (B) of polymerization of resin.

In the hard coat layer, there is a difference between the rate (A) of polymerization of resin and the rate (B) of polymerization of resin, and the rate (A) of polymerization of resin is larger than the rate (B) of polymerization of resin, and the surface on the side of the light-transmitting substrate is harder than the surface opposite to the light-transmitting substrate.

In addition, the rate A of polymerization and the rate B of polymerization were determined by measuring the hard coat layer with the use of Raman spectroscopy and calculating from the following equation.

Rate of polymerization=[ratio of peak at 1636 cm⁻¹/peak at 1730 cm⁻¹ of unreacted material]−[ratio of peak at 1636 cm⁻¹/peak at 1730 cm⁻¹ of sample]/[ratio of peak at 1636 cm⁻¹/peak at 1730 cm⁻¹ of unreacted material]−[ratio of peak at 1636 cm⁻¹/peak at 1730 cm⁻¹ of completely hardened material]×100(%)

In the above equation, 1636 cm⁻¹ indicates the peak of C═C and 1736 cm⁻¹ indicates the peak of C═O.

The definition of complete hardening is such that when a hard coat layer hardened by ultraviolet light is heated in a nitrogen atmosphere in DSC, and a straight line is horizontally drawn with reference to 150° C., an exothermic peak is not recognized until a temperature reaches 350° C.

In determining the rate of polymerization, a cross-section was prepared in the vertical direction with Ultramicrotome, and the rate of polymerization is measured on the face with an Ra of 50 nm or less (3 μm square, tapping mode, number of measuring points 1024, analyzed data after measurement is not corrected) of the cross-section with an atomic force microscope (AFM).

If the thickness of the hard coat layer from the surface opposite to the light-transmitting substrate to the surface on the side of the light-transmitting substrate is denoted by X₂ (μm) and the rate of polymerization of resin at the thickness X₂ (μm) is denoted by Y₂%, a variation in the rate of polymerization of resin within the hard coat layer is represented by Formula (2):

In Y₂=A×X₂+B,−1.3≦A≦−0.2 and 50≦B≦75 Formula (2).

If A is less than −1.3 in Formula (2), damage such as curling tends to occur in the optical layered body of the present invention, and if A exceeds −0.2, the hard coat layer becomes too soft and the hardness may be insufficient.

A in Formula (2) more preferably satisfies the relationship of −1.2≦A≦−0.5.

By forming the hard coat layer having such a rate of polymerization of resin, an optical layered body can be an optical layered body which hardly causes curling, has excellent durability while maintaining high pencil hardness, and prevents the degradation of an image display screen by external light.

The film thickness of the hard coat layer can be appropriately set, but in general, it is preferably 0.5 to 20 μm. If the film thickness is less than 0.5 μm, the functions required of the hard coat layer, for example, pencil hardness, may be insufficient. On the other hand, if the film thickness exceeds 20 μm, the amount of a resin used for forming the hard coat layer increases, which leads to a rise of the production cost, and further the hard coat layer is vulnerable to damage such as wrinkles. The film thickness of the hard coat layer is more preferably 2 to 15 μm.

The film thickness was measured through observation by a laser microscope manufactured by Lica AG.

A thickness from the surface at the time of measuring the Martens hardness is measured by pushing depth.

As the light-transmitting substrate, a material which has smoothness and heat resistance and is excellent in mechanical strength is preferable.

Specific examples of materials constituting the light-transmitting substrate include thermoplastic resins such as polyethylene terephthalate (PET), polyethylene naphthalate, polybutylene terephthalate, polybutylene naphthalate, triacetyl cellulose (TAC), cellulose diacetate, cellulose acetate butylate, polyamide, polyimide, polyethersulfone, polysulfone, polypropylene (PP), cycloolefin (COP), polymethylpentene, polyvinyl chloride, polyvinyl acetal, polyether ketone, polymethyl methacrylate, polycarbonate and polyurethane, and examples of preferable materials include polyethylene terephthalate, triacetyl cellulose, cycloolefin and polypropylene.

In the optical layered body of the present invention, polyethylene terephthalate is more preferably used as the light-transmitting substrate. When polyethylene terephthalate is used as the light-transmitting substrate, the light-transmitting substrate has advantages over other transmitting substrate s from the viewpoints of heat resistance, flexibility and cost also in a thin film article.

In the present invention, polyethylene terephthalate can be suitably used as the light-transmitting substrate. If the ultraviolet absorber is added in order to prevent the degradation of the substrate itself, or a polarizer, a color filter or a liquid crystal molecule, in which the optical layered body is disposed, by ultraviolet light, for example, in the case of a triacetyl cellulose substrate, it is easy to add the ultraviolet absorber to the substrate itself since the triacetyl cellulose substrate is formed by a casting method. However, in the case of a polyethylene terephthalate substrate, since the polyethylene terephthalate substrate is formed by an extrusion method, it is difficult to add an usual ultraviolet absorber because it has no heat resistance and tends to evaporate, and therefore the polyethylene terephthalate substrate having an ultraviolet light-absorbing property is expensive. In the present invention, since the hard coat layer contains a specific ultraviolet absorber, the degradation of the substrate itself due to ultraviolet light can be prevented even when addition of the ultraviolet absorber to the substrate is difficult.

The light-transmitting substrate preferably has a thickness of 20 to 80 μm, and more preferably, has a thickness in a lower limit of 25 μm and an upper limit of 50 μm.

When a hard coat layer or the like is formed on the light-transmitting substrate, the light-transmitting substrate may be subjected to physical treatments such as a corona discharge treatment and an oxidation treatment in advance, and in addition an anchor agent or a coating material such as a primer may be applied onto the light-transmitting substrate in advance in order to improve the adhesive property of the light-transmitting substrate.

If polyethylene terephthalate is used as the light-transmitting substrate, when the hard coat layer is formed directly on the substrate, the adhesive property of an interface between the polyethylene terephthalate substrate and the hard coat layer is low. Further, when a difference in refractive index at the interface is large, the contrast may be deteriorated or interference fringes may appear. It is preferred to provide a primer layer between the polyethylene terephthalate substrate and the hard coat layer in order to prevent such drawbacks.

The primer layer is preferably a layer which has a high adhesive property to both of the polyethylene terephthalate and the hard coat, and has a refractive index intermediate between the polyethylene terephthalate and the hard coat.

The contrast can be improved and interference fringes can be prevented by a method of forming a diffusion layer containing a diffusion agent including inorganic and/or organic fine particles, by a method of roughening an interface, or the like.

The optical layered body may include an arbitrary layer in addition to the hard coat layer and the light-transmitting substrate. Examples of the arbitrary layer include an antiglare layer, an antistatic layer, a low refractive index layer, an antifouling layer, a high refractive index layer, a medium refractive index layer and other hard coat layers. These layers can be formed by mixing publicly known antiglare agents, antistatic agents, low refractive index agents, high refractive index agents or antifouling agents with a resin, a solvent or the like with the use of a publicly known method.

The optical layered body of the present invention preferably has a transmittance of 15% or less at a wavelength of 380 nm after the optical layered body is left standing for 100 hours in an environment of 80° C. and 90% RH. If the transmittance at a wavelength of 380 nm is 15% or less, the degradation, due to ultraviolet light, of a substrate, a liquid crystal or the like located at a position of a lower layer can be prevented. The transmittance is preferably 10% or less.

The transmittance can be measured by using a commercially available apparatus, for example, “spectrophotometer UV-2450” manufactured by SHIMADZU Corporation.

The optical layered body of the present invention hardly causes curling as described above.

Specifically, if the optical layered body of the present invention is cut into a square sheet having a size of 10 cm long and 10 cm wide, and the sheet is suspended by holding two points on a side in the transverse direction of the sheet, which are respectively 4 mm away from the midpoint of the side in the transverse direction, a minimum distance between a line joining the respective midpoints of two sides in the transverse direction of the sheet and a line joining the respective midpoints of two sides in the length direction of the sheet is preferably 30 mm or less. The minimum distance is more preferably 10 mm or less.

In addition, when the optical layered body is placed horizontally and a degree of curling of the optical layered body is measured, a degree of curling produced by shrinkage through polymerization changes due to weights of materials themselves such as the light-transmitting substrate and the hard coat layer. Therefore, the optical layered body is vertically suspended with a center of a side of the sheet held, and the warpage of a left side and a right side of the optical layered body relative to a central portion of the optical layered body is measured, and thereby, an actual degree of curling due to distortion can be evaluated.

The optical layered body of the present invention preferably has a hardness of class “H” or higher, more preferably “2H” or higher, and moreover preferably “3H” or higher in a scratch hardness test by pencil method (load 4.9 N) of JIS K 5600-5-4 (1999).

Examples of a method of producing an optical layered body of the present invention include a production method including the steps of applying the above-mentioned composition for a hard coat layer containing a polyfunctional (meth)acrylate ultraviolet curable resin, an ultraviolet absorber and a photopolymerization initiator onto the light-transmitting substrate to form a coating film; and irradiating the formed coating film with ultraviolet light of a lamp power of 100 to 1000 W/cm and an amount of irradiation of 15 to 1000 mJ/cm² to harden the coating film, followed by formation of a hard coat layer.

Further, a calorific value is 450 J/g or less in the case where the composition for a hard coat layer is formed into a coating film having a dried film thickness of 200 μm and the coating film is irradiated with ultraviolet light at an amount of irradiation of 150 mJ/cm².

The composition for a hard coat layer can be prepared by using the same materials and method as those in the above-mentioned composition for a hard coat layer. Examples of the method of forming a hard coat layer include the same method as in the above-mentioned method of forming a hard coat layer. The method of producing an optical layered body of the present invention as described above also constitutes the present invention.

The optical layered body of the present invention can be formed into a polarizer by providing the optical layered body on the surface of a polarizing element opposite to the hard coat layer in the light-transmitting substrate.

The polarizing element is not particularly limited, and for example, a polyvinyl alcohol film, a polyvinyl formal film, a polyvinyl acetal film or an ethylene-vinyl acetate copolymer saponified film, which is dyed with iodine or the like and stretched, can be used. In laminating the polarizing element and the optical layered body, the light-transmitting substrate is preferably subjected to a saponification treatment. The adhesive property between the polarizing element and the optical layered body becomes good by the saponification treatment, and thus an antistatic effect can be attained.

If the light-transmitting substrate is polyethylene terephthalate and the optical layered body of the present invention is bonded to the polarizing element, the face of the light-transmitting substrate on which the hard coat layer is not formed is preferably bonded to the polarizing element by using a pressure sensitive adhesive. Examples of the pressure sensitive adhesive include an ultraviolet curable pressure sensitive adhesive and a water pressure sensitive adhesive.

In addition, if the ultraviolet curable pressure sensitive adhesive is used as the pressure sensitive adhesive, when a certain amount or more of the ultraviolet absorber remains in the hard coat layer, there is a possibility that light (ultraviolet light), which has entered from the surface opposite to the light-transmitting substrate of the optical layered body, is absorbed in the hard coat layer and does not reach a pressure sensitive adhesive layer, and therefore the pressure sensitive adhesive layer is not adequately hardened and the optical layered body cannot be adequately bonded to the polarizing element.

Therefore, as described above, in the optical layered body of the present invention, the product of the film thickness (μm) of the hard coat layer and the concentration (mass %) of the ultraviolet absorber in the hard coat layer is preferably 4 to 150 (μm×mass %).

The optical layered body of the present invention or the above-mentioned polarizer may be disposed at the outermost surfaces of an image display device.

The image display device may be a non-self-luminous image display device such as an LCD, or may be a self-luminous image display device such as a PDP, an FED, an ELD (organic EL, inorganic EL) or a CRT.

An LCD, which is a typical example of the non-self-luminous type, includes a light-transmitting display and a light source apparatus to irradiate the light-transmitting display from the backside. If the image display device of the present invention is an LCD, the optical layered body or the polarizer is formed on the surface of this light-transmitting display.

In the case of a liquid crystal display device having the optical layered body of the present invention, a light source of a light source apparatus irradiates from the side of the light-transmitting substrate of the optical layered body. In addition, in an SNT type liquid crystal display device, a retardation plate may be inserted between a liquid crystal display element and a polarizer. An adhesive layer may be provided between the respective layers of the liquid crystal display device as required.

A PDP, which is the self-luminous image display device, includes a surface glass substrate (provided with an electrode thereon) and a backside glass substrate (provided with an electrode and a minute groove formed thereon, in the groove of which red, green and blue phosphor layers are formed) which is located at a position opposite to the surface glass substrate with a discharge gas filled between these substrates. If the image display device of the present invention is a PDP, the optical layered body described above is formed on the surface of the surface glass substrate or a front plate (glass substrate or film substrate) thereof.

The self-luminous image display device may be an ELD apparatus in which luminous bodies of zinc sulfide or diamines substances to emit light through the application of a voltage are deposited on a glass substrate by vapor deposition and display is performed by controlling a voltage to be applied to the substrate, or an image display devices such as CRT, which converts electric signals to light to generate visible images. In this case, the image display device includes the optical layered body described above on the outermost surface of each of the display devices or on the surface of the front plate thereof.

The optical layered body of the present invention can be used for displays such as televisions, computers, electronic paper terminals and the like in any case. Particularly, it can be suitably used for the surfaces of displays for high-resolution images such as CRTs, liquid crystal panels, PDPs, ELDs and FEDs.

### Effects of the Invention

Since the optical layered body of the present invention is constituted as described above, it hardly causes deformation such as curling, and has high pencil hardness and excellent durability. Moreover, if the optical layered body of the present invention is used as a protective film of an image display screen, the degradation of durability of the image display screen by external light can be prevented. Therefore, the optical layered body of the present invention can be suitably used for cathode ray tube (CRT) display devices, liquid crystal displays (LCD), plasma displays (PDP), electroluminescence displays (ELD), field-emission displays (FED), electronic paper terminals and the like.

### MODE FOR CARRYING OUT THE INVENTION

Hereinafter, the present invention will be described in more detail by way of examples and comparative examples, but the present invention is not limited to these examples and comparative examples.

In addition, “part(s)” or “%” refers to “part(s) by mass” or “% by mass” in examples and comparative examples, unless otherwise specified.

### Production Example 1

### Preparation of Coating Solution for Hard Coat Layer

The following materials were sufficiently mixed to prepare compositions. These compositions were filtered with a polypropylene filter with a pore size of 30 μm to prepare coating solutions (1) to (3) for a hard coat layer.

### <Coating Solution for Hard Coat Layer (1) (Solid Content 45% by Mass)>

### Ultraviolet Curable Resin:

Pentaerythritol triacrylate (PETA) 91.9 parts by mass Cellulose acetate propionate (molecular weight 50000) 1.2 parts by mass

### Photopolymerization Initiator:

Irgacure 184 (produced by Ciba Specialty Chemicals Inc.) 4.8 parts by mass
Irgacure 907 (produced by Ciba Specialty Chemicals Inc.) 1.0 part by mass
Irgacure 127 (produced by Ciba Specialty Chemicals Inc.) 1.0 part by mass
Silicon leveling agent 0.1 parts by mass

### Solvent:

Toluene 97.6 parts by mass
Methyl isobutyl ketone (MIBK) 24.4 parts by mass

### <Coating Solution for Hard Coat Layer (2) (Solid Content 45% by Mass)>

### Ultraviolet Curable Resin:

Pentaerythritol triacrylate (PETA) 43.1 parts by mass
Urethane acrylate (UV-1700B, produced by Nippon Synthetic
Chemical Industry Co., Ltd.) 50.0 parts by mass

### Photopolymerization Initiator:

Irgacure 184 (produced by Ciba Specialty Chemicals Inc.) 4.8 parts by mass
Irgacure 907 (produced by Ciba Specialty Chemicals Inc.) 1.0 part by mass
Irgacure 127 (produced by Ciba Specialty Chemicals Inc.) 1.0 part by mass
Silicon leveling agent 0.1 parts by mass

### Solvent:

Toluene 97.6 parts by mass
Methyl isobutyl ketone (MIBK) 24.4 parts by mass

### <Coating Solution for Hard Coat Layer (3) (Solid Content 45% by Mass)>

### Ultraviolet Curable Resin:

Pentaerythritol triacrylate (PETA) 43.1 parts by mass
Urethane acrylate (Beamset 371, produced by Arakawa Chemical Industries, Ltd.) 50.0 parts by mass

### Photopolymerization Initiator:

Irgacure 184 (produced by Ciba Specialty Chemicals Inc.) 4.8 parts by mass
Irgacure 907 (produced by Ciba Specialty Chemicals Inc.) 1.0 part by mass
Irgacure 127 (produced by Ciba Specialty Chemicals Inc.) 1.0 part by mass
Silicon leveling agent 0.1 parts by mass

### Solvent:

Toluene 97.6 parts by mass
Methyl isobutyl ketone (MIBK) 24.4 parts by mass

### Production Example 2

### Preparation of Ultraviolet Absorber Solution

Each of the following ultraviolet absorbers was dissolved in a solution composed of toluene and methyl isobutyl ketone in proportions of 70:30 (by weight) in such a way that the content of each ultraviolet absorber is 45% by mass to prepare an ultraviolet absorber solution.

a-1) TINUVIN 479 (produced by Ciba Specialty Chemicals Inc., molecular weight 678)
a-2) Compound of Structural Formula 1 (molecular weight 736)
a-3) Compound of Structural Formula 2 (molecular weight 680)
a-4) Compound having a weight average molecular weight of 25000, obtained by copolymerizing 65% by mass of a compound of Structural Formula 3 and 35% by mass of MMA (methyl methacrylate)
a-5) PUVA-30M ((RUVA-93): MMA=30:70, weight average molecular weight 10000)
a-6) Compound having a weight average molecular weight of 20000, obtained by copolymerizing 65% by mass of a compound of Structural Formula 4 and 35% by mass of MMA
a-7) Compound having a weight average molecular weight of 18000, obtained by copolymerizing 65% by mass of a compound of Structural Formula 5 and 35% by mass of MMA
a-8) 2,2-Dihydroxy-4,4-dimethoxybenzophenone (molecular weight 274)
a-9) 2-(2′-Hydroxy-3-tert-butyl-5-methylphenyl)-5-chlorobenzotriazole (molecular weight 318)
a-10) RUVA-93 (produced by Otsuka Chemical Co., Ltd., molecular weight 323)

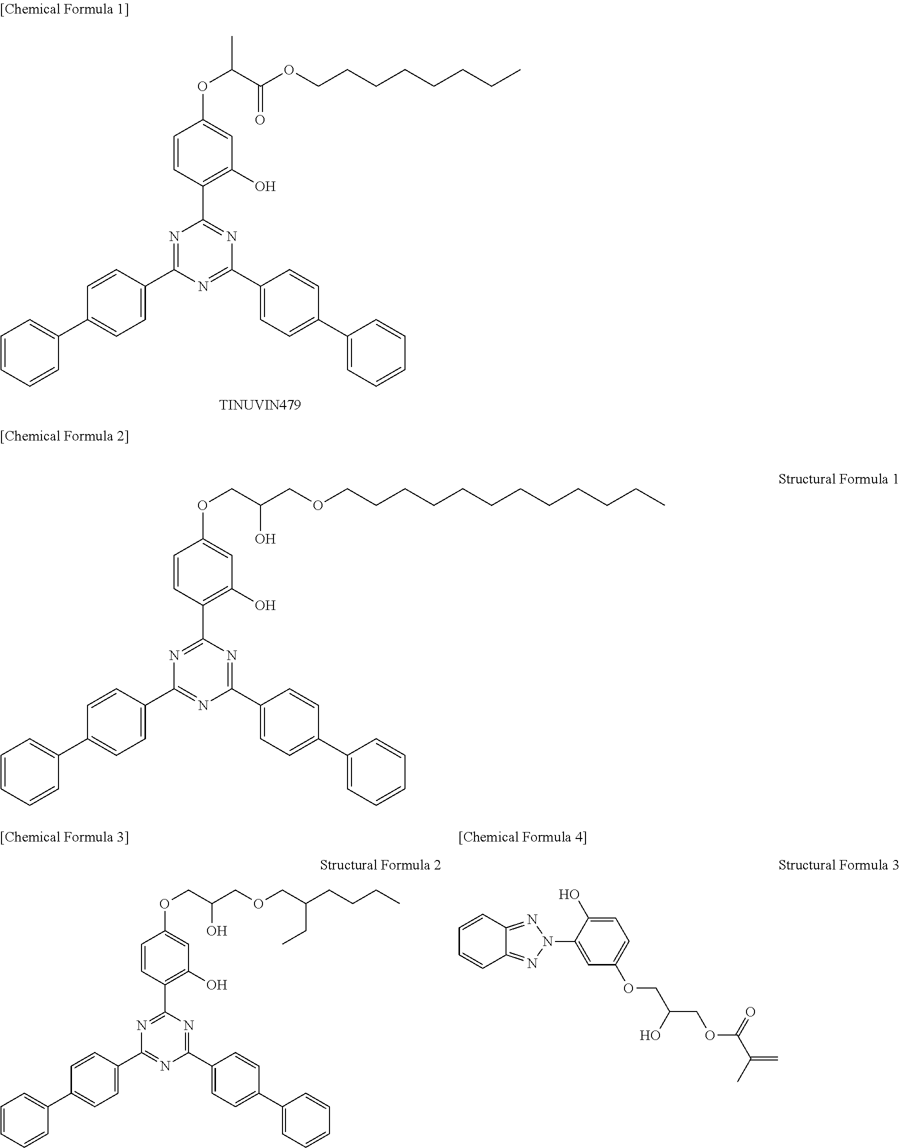

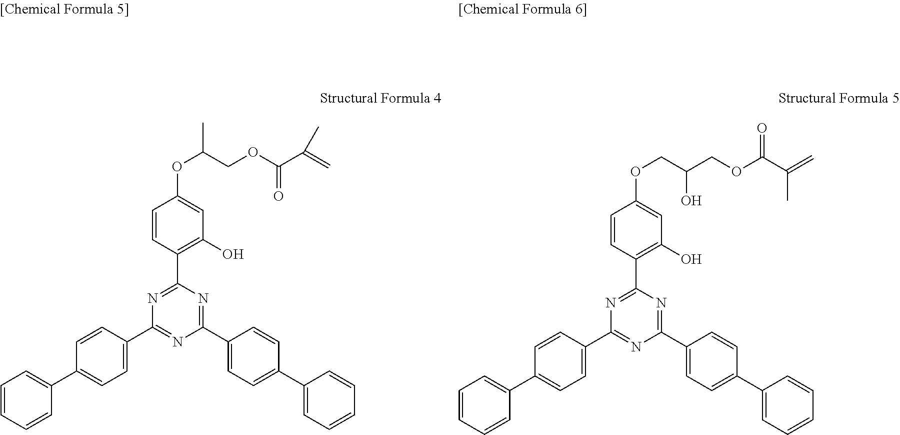

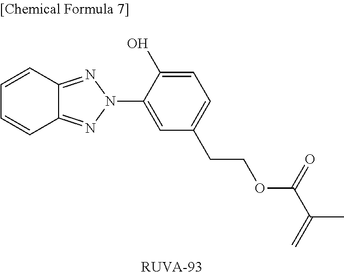

### Examples 1 to 17 and Comparative Examples 1 to 10

The ultraviolet absorber solution obtained in Production Example 2 was mixed in the coating solution for a hard coat layer obtained in Production Example 1 in a predetermined amount to prepare a composition for a hard coat layer. The obtained composition for a hard coat layer was applied onto a substrate, dried for 1 minute with a hot air dryer of 70° C., and irradiated with ultraviolet light under nitrogen purge (oxygen content: 200 ppm or less) in such a way that the total amount of irradiation becomes a predetermined amount at one irradiation by using a high-pressure mercury lamp with an output of 240 W/cm manufactured by Fusion UV Systems Japan K.K. and adjusting an ultraviolet light output rate to prepare an optical layered body having a hard coat layer.

In addition, each of the substrate, coating solution for a hard coat layer, ultraviolet absorber and the concentration thereof, additives, lamp output, amount of ultraviolet irradiation, and film thickness of a hard coat layer, which are used, are as shown in Table 1.

Further, specific substrates and additives, which were used, are shown below.

### Substrate:

T-80) TAC film “TD80UL” (80 μm) produced by FUJIFILM Corporation
T-40) TAC film “KC4UYW” (40 μm) produced by KONICA MINOLTA HOLDINGS, Inc.
P-38) Polyester film including primer with a refractive index of 1.55 “A4300” (38 μm) produced by TOYOBO Co., Ltd.
Antiglare Property Imparting Agent (Silica and/or Organic Resin Bead):
b-1) Methyl methacrylate-styrene crosslinked copolymer beads (average particle diameter: 3.5 μm, refractive index: 1.555)
b-2) Amorphous silica (average particle diameter: 3.0 μm)

### Other Additives:

x-1) System in which 1.5 parts of TINUVIN 123 and 2 parts of Irgacure 819 (both produced by Ciba Specialty Chemicals Inc.) are added to the solid content of the above-mentioned coating solution
x-2) System in which 1.5 parts of FA 712HM (produced by Hitachi Chemical Co., Ltd.) and 2 parts of Irgacure 819 are added to the solid content of the above-mentioned coating solution

TABLE 1

| | | Coating | | | Film | Concen- | | | | | | |
|---|---|---|---|---|---|---|---|---|---|---|---|---|
| | | solution | | Molecular | thickness | tration | | Antiglare property | | | | Ultraviolet |
| | Base | for | Kinds of | weight of | of | of ultraviolet | μm · | imparting agent and | | | Lamp | irradiation |
| | mate- | hard coat | ultraviolet | ultraviolet | hard coat | absorber | % by | its concentration | | Other | output | amount |
| | rial | layer | absorber | absorber | layer (μm) | (% by mass) | mass | (% by mass) | | additives | (W/cm) | (mJ/cm²) |
| Example 1 | T-40 | (1) | a-1 | 677 | 4.5 | 12 | 54 | not used | 0 | not used | 240 | 250 |
| Example 2 | P-38 | (1) | a-1 | 677 | 4.5 | 12 | 54 | not used | 0 | not used | 240 | 250 |
| Example 3 | P-38 | (1) | a-2 | 736 | 4.5 | 12 | 54 | not used | 0 | not used | 240 | 250 |
| Example 4 | P-38 | (1) | a-3 | 680 | 4.5 | 12 | 54 | not used | 0 | not used | 240 | 250 |
| Example 5 | P-38 | (1) | a-4 | about 25000 | 4.5 | 12 | 54 | not used | 0 | not used | 240 | 250 |
| Example 6 | P-38 | (1) | a-5 | about 10000 | 4.5 | 12 | 54 | not used | 0 | not used | 240 | 250 |
| Example 7 | P-38 | (1) | a-6 | about 20000 | 4.5 | 12 | 54 | not used | 0 | not used | 240 | 250 |
| Example 8 | P-38 | (1) | a-7 | about 18000 | 4.5 | 12 | 54 | not used | 0 | not used | 240 | 250 |
| Example 9 | P-38 | (1) | a-1 | 677 | 4.5 | 12 | 54 | not used | 0 | x-1 | 240 | 300 |
| Example 10 | P-38 | (1) | a-1 | 677 | 4.5 | 12 | 54 | not used | 0 | x-2 | 240 | 300 |
| Example 11 | P-38 | (1) | a-1 | 677 | 4.5 | 12 | 54 | b-1 | 8 | not used | 240 | 250 |
| Example 12 | P-38 | (1) | a-1 | 677 | 3.1 | 12 | 36 | b-2 | 5 | not used | 240 | 250 |
| Example 13 | P-38 | (1) | a-1 | 677 | 6 | 10 | 60 | b-1 | 8 | not used | 240 | 250 |
| Example 14 | P-38 | (2) | a-1 | 677 | 4.5 | 12 | 54 | b-1 | 8 | not used | 240 | 250 |
| Example 15 | P-38 | (3) | a-1 | 677 | 4.5 | 12 | 54 | b-1 | 8 | not used | 240 | 250 |
| Example 16 | P-38 | (1) | a-1 | 677 | 4.5 | 16 | 72 | b-1 | 8 | not used | 240 | 250 |
| Example 17 | P-38 | (1) | a-1 | 677 | 6 | 12 | 72 | b-1 | 8 | not used | 240 | 250 |
| Comparative | T-80 | (1) | not used | — | 4.5 | 0 | 0 | not used | 0 | not used | 240 | 250 |
| Example 1 | | | | | | | | | | | | |
| Comparative | T-40 | (1) | not used | — | 4.5 | 0 | 0 | not used | 0 | not used | 240 | 250 |
| Example 2 | | | | | | | | | | | | |
| Comparative | P-38 | (1) | not used | — | 4.5 | 0 | 0 | not used | 0 | not used | 240 | 250 |
| Example 3 | | | | | | | | | | | | |
| Comparative | P-38 | (1) | a-8 | 274 | 4.5 | 12 | 54 | not used | 0 | not used | 240 | 250 |
| Example 4 | | | | | | | | | | | | |
| Comparative | P-38 | (1) | a-9 | 316 | 4.5 | 12 | 54 | not used | 0 | not used | 240 | 250 |
| Example 5 | | | | | | | | | | | | |
| Comparative | P-38 | (1) | a-1 | 677 | 15 | 12 | 180 | not used | 0 | not used | 240 | 250 |
| Example 6 | | | | | | | | | | | | |
| Comparative | P-38 | (1) | a-8 | 274 | 4.5 | 36 | 162 | not used | 0 | not used | 240 | 250 |
| Example 7 | | | | | | | | | | | | |
| Comparative | P-38 | (1) | a-8 | 274 | 4.5 | 0.5 | 2.25 | not used | 0 | not used | 240 | 250 |
| Example 8 | | | | | | | | | | | | |
| Comparative | P-38 | (1) | a-10 | 323 | 4.5 | 10 | 45 | not used | 0 | not used | 240 | 250 |
| Example 9 | | | | | | | | | | | | |
| Comparative | P-38 | (1) | a-1 | 677 | 5.5 | 30 | 165 | not used | 0 | not used | 240 | 250 |
| Example 10 | | | | | | | | | | | | |

The following items of the obtained optical layered bodies in examples and comparative examples were evaluated. The results of evaluations are shown in Table 2.

### (Transmittance at 380 nm)

The transmittance (%) was measured by using “spectrophotometer UV-2450” manufactured by SHIMADZU Corporation.

When the transmittance at a wavelength of 380 nm is 15% or less, it is favorable since the degradation of a substrate or a liquid crystal at a normal state can be prevented.

### (Transmittance in Durability)

The transmittance at a wavelength of 380 nm was measured after leaving the optical layered body standing for 500 hours in an environment of 80° C. and 90% RH.

When the transmittance thus measured is also 15% or less, the transmittance in durability is rated as good.

### (Evaluation of Degree of Curling)

The film irradiated with ultraviolet light was immediately cut out into a square sheet having a size of 10 cm long and 10 cm wide, and left for a day in an environment of 25° C. and 50% RH, and then the sheet was suspended by holding two points on a side in the transverse direction of the sheet, which were respectively 4 mm away from the midpoint of the side in the transverse direction in an environment of 23° C. and 65% RH, and a minimum distance between a line joining the respective midpoints of two sides in the transverse direction of the sheet and a line joining the respective midpoints of two sides in the length direction of the sheet was measured and evaluated according to the following criteria.

◯: 10 mm or less
Δ: more than 10 mm and 30 mm or less
x: more than 30 mm

### (Pencil Hardness)

The pencil hardness was evaluated at a load of 500 g according to a scratch hardness test by pencil method of JIS K 5600-5-4 (1999).

(Martens Hardness within Hard Coat Layer (N/mm²))

The Martens hardness at the surface and the Martens hardness at the surface on the side of the substrate were obtained by following a procedure in which an ultramicrohardness measurement system “FISCHERSCOPE PICODENTOR HM500 made in 2007” manufactured by Fischer Instruments K.K. was used, and if the film thickness of the hard coat layer was about 4.5 μm, pushing strength was varied, and the hardness in the vicinity of the surface of the hard coat layer (3 mN, a portion at a depth of about 0.5 μm from the surface) and the hardness in the vicinity of an interface between the hard coat layer and the light-transmitting substrate (80 mN, a portion at a depth of about 4 μm from the surface) were measured to obtain the Martens hardness at the surface and the Martens hardness at the surface on the side of the substrate. Further, if the film thickness of the hard coat layer was about 3 μm or 6 μm, similarly, pushing strength to a portion at a depth of about 0.5 μm from the surface, and pushing strength to a portion at a depth of (film thickness of hard coat—0.5) μm from the surface were measured to obtain the Martens hardness at the surface and the Martens hardness at the surface on the side of the substrate.

(Rate of Polymerization of Resin within Hard Coat Layer (%))

The rates of polymerization of resin of the surface within the hard coat layer and the side of the substrate were determined by measuring at a measurement wavelength of 633 nm under the conditions of an accumulation of 20 seconds 10 times and a line scanning interval of 0.5 μm by the use of Raman spectroscopy (LabRAM HR-800 manufactured by Horiba, Ltd.) and calculating from the following equation.

Rate of polymerization=[(ratio of peak at 1636 cm⁻¹/peak at 1730 cm⁻¹ of unreacted material)−(ratio of peak at 1636 cm⁻¹/peak at 1730 cm⁻¹ of sample)]/[(ratio of peak at 1636 cm⁻¹/peak at 1730 cm⁻¹ of unreacted material)−(ratio of peak at 1636 cm⁻¹/peak at 1730 cm⁻¹ of completely hardened material)]×100(%)

In the above equation, 1636 cm⁻¹ indicates the peak of C═C and 1736 cm⁻¹ indicates the peak of C═O.

The definition of complete hardening was such that when a hard coat layer hardened by ultraviolet light was heated in a nitrogen atmosphere in DSC, and a straight line was horizontally drawn with reference to 150° C., an exothermic peak was not recognized until a temperature reached 350° C.

In determining the rate of polymerization, a cross-section of the optical layered body was prepared in the vertical direction with Ultramicrotome, and the rate of polymerization was measured on the face with an Ra of 50 nm or less (3 μm square, tapping mode, number of measuring points 1024, analyzed data after measurement is not corrected) of the cross-section with an atomic force microscope (AFM).

TABLE 2

| | | | | | Martens hardness | | | Rate of Polymerization | | | |
|---|---|---|---|---|---|---|---|---|---|---|---|
| | | | | | within hard | | | of Resin within | | | |
| | | | | | coat layer (N/mm²) | | | Hard Coat Layer (%) | | | |
| | Transmittance | Transmittance | | | | Side surface | | | Side surface | A in | B in |
| | at 380 nm | in durability | | Pencil | Surface | (B) of | Y₁/X₁ | Surface | B of | Formula | Formula |
| | (%) | (%) | Curling | hardness | (A) | base material | (Note 1) | A | base material | (2) | (2) |
| Example 1 | 2 | 2 | ◯ | 3H | 282 | 207 | 16.7 | 59 | 58 | −0.22 | 59 |
| Example 2 | 9 | 9 | ◯ | 2H | 268 | 182 | 19.1 | 59 | 55 | −0.89 | 59 |
| Example 3 | 10 | 9 | ◯ | 2H | 283 | 194 | 19.8 | 62 | 58 | −0.89 | 62 |
| Example 4 | 10 | 9 | ◯ | 2H | 283 | 194 | 19.8 | 62 | 58 | −0.89 | 62 |
| Example 5 | 11 | 10 | ◯ | 2H | 271 | 189 | 18.2 | 60 | 57 | −0.67 | 60 |
| Example 6 | 10 | 9 | ◯ | 2H | 271 | 194 | 17.1 | 61 | 58 | −0.67 | 61 |
| Example 7 | 11 | 10 | ◯ | 3H | 284 | 201 | 18.4 | 62 | 59 | −0.67 | 62 |
| Example 8 | 12 | 11 | ◯ | 3H | 285 | 204 | 18.0 | 63 | 59 | −0.89 | 63 |
| Example 9 | 8 | 8 | ◯ | 2H | 268 | 183 | 18.9 | 59 | 55 | −0.89 | 59 |
| Example 10 | 8 | 8 | ◯ | 2H | 269 | 181 | 19.6 | 59 | 55 | −0.89 | 59 |
| Example 11 | 11 | 11 | ◯ | 2H | 275 | 196 | 17.6 | 62 | 58 | −0.89 | 62 |
| Example 12 | 12 | 12 | ◯ | 3H | 286 | 206 | 25.8 | 63 | 60 | −0.97 | 63 |
| Example 13 | 10 | 10 | ◯ | 3H | 280 | 189 | 15.2 | 61 | 56 | −0.83 | 61 |
| Example 14 | 10 | 10 | ◯ | 2H | 279 | 190 | 19.8 | 61 | 57 | −0.89 | 61 |
| Example 15 | 11 | 11 | ◯ | 3H | 286 | 195 | 20.2 | 63 | 58 | −1.11 | 63 |
| Example 16 | 11 | 11 | ◯ | 2H | 233 | 164 | 15.8 | 59 | 54 | −1.11 | 59 |
| Example 17 | 10 | 10 | ◯ | 3H | 310 | 221 | 16.5 | 67 | 60 | −1.17 | 67 |
| Comparative | 5 | 5 | X | 3H | 322 | 300 | 4.9 | 90 | 88 | −0.44 | 90 |
| Example 1 | | | | | | | | | | | |
| Comparative | 5 | 5 | X | 2H | 336 | 301 | 7.8 | 90 | 88 | −0.44 | 90 |
| Example 2 | | | | | | | | | | | |
| Comparative | 77 | 76 | X | 2H | 323 | 294 | 6.4 | 88 | 85 | −0.66 | 88 |
| Example 3 | | | | | | | | | | | |
| Comparative | 5 | 50 | Δ | H | 180 | 171 | 2.0 | 55 | 51 | −0.88 | 55 |
| Example 4 | | | | | | | | | | | |
| Comparative | 7 | 67 | Δ | H | 194 | 180 | 3.1 | 58 | 55 | −0.67 | 58 |
| Example 5 | | | | | | | | | | | |
| Comparative | 7 | 7 | Δ | B | 240 | 128 | 7.5 | 65 | 38 | −1.80 | 65 |
| Example 6 | | | | | | | | | | | |
| Comparative | 2 | 55 | Δ | B | 182 | 169 | 2.9 | 55 | 50 | −1.11 | 55 |
| Example 7 | | | | | | | | | | | |
| Comparative | 65 | 76 | X | 2H | 320 | 294 | 5.8 | 88 | 85 | −0.67 | 88 |
| Example 8 | | | | | | | | | | | |
| Comparative | 28 | 30 | X | H | 287 | 265 | 4.9 | 74 | 70 | −0.89 | 74 |
| Example 9 | | | | | | | | | | | |
| Comparative | 8 | 8 | Δ | B | 265 | 106 | 28.9 | 59 | 43 | −2.91 | 59 |
| Example 10 | | | | | | | | | | | |

(Note 1)
X1: Thickness of hard coat layer (μm)
Y1: Martens hardness (A)-Martens hardness (B) (N/mm²)

It was found from Table 2 that the optical layered bodies in examples have small transmittance of ultraviolet light and excellent durability of preventing the degradation of an image display screen by external light, and have high pencil hardness and hardly cause curling. Further, the optical layered bodies in examples could also favorably impart an antiglare property. On the other hand, there were no optical layered bodies of comparative examples which are excellent in all items.

### Evaluation of Calorific Value

### Examples 18 to 20 and Comparative Example 11

Compositions for a hard coat layer A, B and C, which had the same composition as in the compositions for a hard coat layer used in Examples 1, 5 and 6, respectively, except for changing the amount of the ultraviolet absorber to 0.27% by mass, were prepared. Next, the obtained composition for a hard coat layer A was applied onto a substrate (T-40), and the compositions for a hard coat layer B and C were applied onto a substrate (P-38) to form coating films each having a dried film thickness of 200 μm, and the coating films were irradiated with ultraviolet light of an irradiation intensity of 10 mW/cm² and an amount of irradiation of 150 mJ/cm² to measure the calorific values of the coating films.

Further, by using the composition for a hard coat layer used in Comparative Example 3, a coating film having a dried film thickness of 200 μm was formed on the substrate (P-38) in the same manner as that described above and the calorific value of the coating film was measured. These results are shown in Table 3.

TABLE 3

| | Composition for | Calorific value |
|---|---|---|
| | hard coat layer | (J/g) |
| Example 18 | A | 206 |
| Example 19 | B | 200 |
| Example 20 | C | 220 |
| Comparative | Comparative | 510 |
| Example 11 | Example 3 | |

### INDUSTRIAL APPLICABILITY

The optical layered body of the present invention can be suitably used for cathode ray tube (CRT) display devices, liquid crystal displays (LCD), plasma displays (PDP), electroluminescence displays (ELD), field-emission displays (FED), electronic paper terminals and the like.

1. An optical layered body comprising a light-transmitting substrate and at least a hard coat layer formed on the light-transmitting substrate, wherein
the hard coat layer is formed by hardening a composition for a hard coat layer containing a polyfunctional (meth)acrylate ultraviolet curable resin, an ultraviolet absorber and a photopolymerization initiator by ultraviolet irradiation and wherein
the hard coat layer has a Martens hardness (A) of 230 to 320 N/mm² at the surface opposite to the light-transmitting substrate and has a Martens hardness (B) of 160 to 250 N/mm² at the surface on the side of the light-transmitting substrate, and the Martens hardness (A) is larger than the Martens hardness (B) and the elastic modulus of the hard coat layer varies continuously in the thickness direction.

2. An optical layered body comprising a light-transmitting substrate and at least a hard coat layer formed on the light-transmitting substrate, wherein
the hard coat layer is formed by hardening a composition for a hard coat layer containing a polyfunctional (meth)acrylate ultraviolet curable resin, an ultraviolet absorber and a photopolymerization initiator by ultraviolet irradiation, and wherein
if the thickness of the hard coat layer from the surface opposite to the light-transmitting substrate to the surface on the side of the light-transmitting substrate is denoted by X₁ (μm) and a difference (A−B) between the Martens hardness (A) at the surface of the hard coat layer opposite to the light-transmitting substrate and the Martens hardness (B) at the surface of the hard coat layer on the side of the light-transmitting substrate is denoted by Y₁ (N/mm²), a relationship of the elastic modulus to the thickness of the hard coat layer is represented by Formula (1):
15 N/mm²/μm≦Y₁/X₁≦26 N/mm²/μm Formula (1).

3. The optical layered body according to claim 1, wherein the hard coat layer has a rate (A) of polymerization of resin of 50 to 75% at the surface opposite to the light-transmitting substrate and has a rate (B) of polymerization of resin of 40 to 65% at the surface on the side of the light-transmitting substrate, and the rate (A) of polymerization of resin is larger than the rate (B) of polymerization of resin and the rate of polymerization of resin varies continuously in the thickness direction.

4. The optical layered body according to claim 3, wherein if the thickness of the hard coat layer from the surface opposite to the light-transmitting substrate to the surface on the side of the light-transmitting substrate is denoted by X₂ (μm) and the rate of polymerization of resin at the thickness X₂ (μm) is denoted by Y₂%, a variation in the rate of polymerization of resin within the hard coat layer is represented by Formula (2):
In Y₂=A×X₂+B,−1.3≦A≦−0.2 and 50≦B≦75 Formula (2).

5. The optical layered body according to claim 1, wherein the ultraviolet absorber is an addition-polymerization product of hydroxyphenyl benzotriazole (meth)acrylates, and/or a triazine compound in which four or more benzene rings are added and at least one of the benzene rings is substituted with a hydroxyl group.

6. The optical layered body according to claim 1, wherein at least one of the ultraviolet absorbers has a weight average molecular weight of 500 to 50000, and the product of the film thickness (μm) of the hard coat layer and the concentration (mass %) of the ultraviolet absorber in the hard coat layer is 4 to 150 (μm×mass %).

7. The optical layered body according to claim 6, wherein a calorific value is 450 J/g or less in the case where the composition for a hard coat layer is formed into a coating film having a dried film thickness of 200 μm and the coating film is irradiated with ultraviolet light at an irradiation intensity of 10 mW/cm² at an amount of irradiation of 150 mJ/cm².

8. The optical layered body according to claim 1, wherein the ultraviolet irradiation is carried out under a lamp power of 100 to 1000 W/cm and an amount of irradiation of 15 to 1000 mJ/cm².

9. The optical layered body according to claim 1, wherein the hard coat layer has a film thickness of 0.5 to 20 μm and the light-transmitting substrate has a thickness of 20 to 80 μm.

10. The optical layered body according to claim 1, which has a transmittance of 15% or less at a wavelength of 380 nm after the optical layered body is left standing for 100 hours in an environment of 80° C. and 90% RH.

11. The optical layered body according to claim 1, wherein in the case where the optical layered body is cut into a square sheet having a size of 10 cm long and 10 cm wide, and the sheet is suspended by holding two points on a side in the transverse direction of the sheet, which are respectively 4 mm away from the midpoint of the side in the transverse direction, a minimum distance between a line joining the respective midpoints of two sides in the transverse direction of the sheet and a line joining the respective midpoints of two sides in the length direction of the sheet is 30 mm or less.

12. A method of producing the optical layered body according to claim 1, comprising the steps of:
applying a composition for a hard coat layer containing a polyfunctional (meth)acrylate ultraviolet curable resin, an ultraviolet absorber and a photopolymerization initiator onto a light-transmitting substrate to form a coating film; and
irradiating the formed coating film with ultraviolet light of a lamp power of 100 to 1000 W/cm and an amount of irradiation of 15 to 1000 mJ/cm² to harden the coating film, followed by formation of a hard coat layer, wherein
a calorific value is 450 J/g or less in the case where the composition for a hard coat layer is formed into a coating film having a dried film thickness of 200 μm and the coating film is irradiated with ultraviolet light at an amount of irradiation of 150 mJ/cm².

13. The optical layered body according to claim 2, wherein the hard coat layer has a rate (A) of polymerization of resin of 50 to 75% at the surface opposite to the light-transmitting substrate and has a rate (B) of polymerization of resin of 40 to 65% at the surface on the side of the light-transmitting substrate, and the rate (A) of polymerization of resin is larger than the rate (B) of polymerization of resin and the rate of polymerization of resin varies continuously in the thickness direction.

14. The optical layered body according to claim 2 wherein the ultraviolet absorber is an addition-polymerization product of hydroxyphenyl benzotriazole (meth)acrylates, and/or a triazine compound in which four or more benzene rings are added and at least one of the benzene rings is substituted with a hydroxyl group.

15. The optical layered body according to claim 3 wherein the ultraviolet absorber is an addition-polymerization product of hydroxyphenyl benzotriazole (meth)acrylates, and/or a triazine compound in which four or more benzene rings are added and at least one of the benzene rings is substituted with a hydroxyl group.

16. The optical layered body according to claim 4 wherein the ultraviolet absorber is an addition-polymerization product of hydroxyphenyl benzotriazole (meth)acrylates, and/or a triazine compound in which four or more benzene rings are added and at least one of the benzene rings is substituted with a hydroxyl group.

17. The optical layered body according to claim 2, wherein at least one of the ultraviolet absorbers has a weight average molecular weight of 500 to 50000, and the product of the film thickness (μm) of the hard coat layer and the concentration (mass %) of the ultraviolet absorber in the hard coat layer is 4 to 150 (μm×mass %).

18. The optical layered body according to claim 3, wherein at least one of the ultraviolet absorbers has a weight average molecular weight of 500 to 50000, and the product of the film thickness (μm) of the hard coat layer and the concentration (mass %) of the ultraviolet absorber in the hard coat layer is 4 to 150 (μm×mass %).

19. The optical layered body according to claim 4, wherein at least one of the ultraviolet absorbers has a weight average molecular weight of 500 to 50000, and the product of the film thickness (μm) of the hard coat layer and the concentration (mass %) of the ultraviolet absorber in the hard coat layer is 4 to 150 (μm×mass %).

20. The optical layered body according to claim 5, wherein at least one of the ultraviolet absorbers has a weight average molecular weight of 500 to 50000, and the product of the film thickness (μm) of the hard coat layer and the concentration (mass %) of the ultraviolet absorber in the hard coat layer is 4 to 150 (μm×mass %).
